(19) United States
(12) Patent Application Publication
(10) Pub. No.: US 2026/0274018 A1
(43) Pub. Date: Sep. 17, 2026

(54) HITCH MOUNTING ASSEMBLY WITH AN INTEGRATED RECOVERY ATTACHMENT INTERFACE

(71) Applicant: Ford Global Technologies, LLC, Dearborn, MI (US)

(72) Inventors: Keith WESTON, Canton, MI (US); Fernando Enrique SOSA, Commerce Township, MI (US); Todd SODERQUIST, Canton, MI (US)

(21) Appl. No.: 19/081,448

(22) Filed: Mar. 17, 2025

(51) Int. Cl. B60D 1/52

(52) U.S. Cl. CPC B60D 1/52

(57) ABSTRACT

A hitch assembly of a vehicle may include a body operably coupled to a rear of the vehicle, the body including a first sidewall, a second sidewall, a third sidewall, and a fourth sidewall defining a receiving channel, a hitch attachment interface integrated with the body, and formed on the second sidewall and the fourth sidewall to operably couple a hitch stem disposed at the receiving channel to the body, and a recovery attachment interface integrated with the body. The recovery attachment interface may be separate from the hitch attachment interface, and the recovery attachment interface may be configured to receive and secure an anchor of a soft shackle.

### TECHNICAL FIELD

Example embodiments generally relate to a hitch mounting assembly for a vehicle and, more particularly, relate to a hitch mounting assembly that allows for the secure attachment of a soft shackle to assist in vehicle recovery.

### BACKGROUND

While off-roading, a vehicle may experience a loss of traction and need a recovery event to help regain traction. Typically, vehicles have separate recovery points (e.g. recovery hooks) on the vehicle rear to couple with a soft shackle (e.g. rope loop) to assist in vehicle recovery. However, separate recovery hooks require integration within the vehicle rear and may limit design freedom for a vehicle.

Most off-roading vehicles already include a hitch mounting assembly disposed at the vehicle rear. Typical hitch mounting assemblies may not be compatible with vehicle recovery operations, let alone recovery with a soft shackle. Thus, integrating a recovery interface with the hitch mounting assembly may be desired.

### BRIEF SUMMARY OF SOME EXAMPLES

In accordance with an example embodiment, a hitch mounting assembly of a vehicle may be provided. The hitch assembly may include a body operably coupled to a rear of the vehicle, the body including a first sidewall, a second sidewall, a third sidewall, and a fourth sidewall defining a receiving channel, a hitch attachment interface integrated with the body, and formed on the second sidewall and the fourth sidewall to operably couple a hitch stem disposed at the receiving channel to the body, and a recovery attachment interface integrated with the body. The recovery attachment interface may be separate from the hitch attachment interface, and the recovery attachment interface may be configured to receive and secure an anchor of a soft shackle.

In another example embodiment, a recovery attachment interface of a hitch mounting assembly of a vehicle may be provided. The hitch assembly may include a body operably coupled to a rear of the vehicle, the body including a first sidewall, a second sidewall, a third sidewall, and a fourth sidewall defining a receiving channel, a hitch attachment interface integrated with the body, and formed on the second sidewall and the fourth sidewall to operably couple a hitch stem disposed at the receiving channel to the body, and the recovery attachment interface may be integrated with the body. The recovery attachment interface may be separate from the hitch attachment interface, and the recovery attachment interface may be configured to receive and secure an anchor of a soft shackle.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a hitch mounting assembly for a vehicle in accordance with an example embodiment;

FIG. 2 illustrates a perspective view of the rear of the vehicle in accordance with an example embodiment;

FIG. 3 depicts a lower view of the rear of the vehicle in accordance with an example embodiment;

FIG. 4 illustrates a perspective view of the hitch mounting assembly in accordance with an example embodiment;

FIG. 5 depicts a cross-section view of the hitch mounting assembly in accordance with an example embodiment;

FIG. 6 illustrates a cross-section view of the hitch mounting assembly in accordance with an example embodiment;

FIG. 7 depicts a block diagram of the recovery attachment interface with integrated accessories in accordance with an example embodiment;

FIG. 8 illustrates a perspective view of the hitch mounting assembly in accordance with an example embodiment; and

FIG. 9 depicts a cross-section view of the hitch mounting assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about” and “substantially” should be understood to be definite approximations that account for variations in measurements that cannot be, or as one of skill in the art would appreciate, normally are not, measured precisely. Thus, for example, a parameter that is “about” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a hitch mounting assembly with an integrated recovery attachment interface. As a result, the hitch mounting assembly has increased function and added compatibility with a soft shackle recovery mechanism.

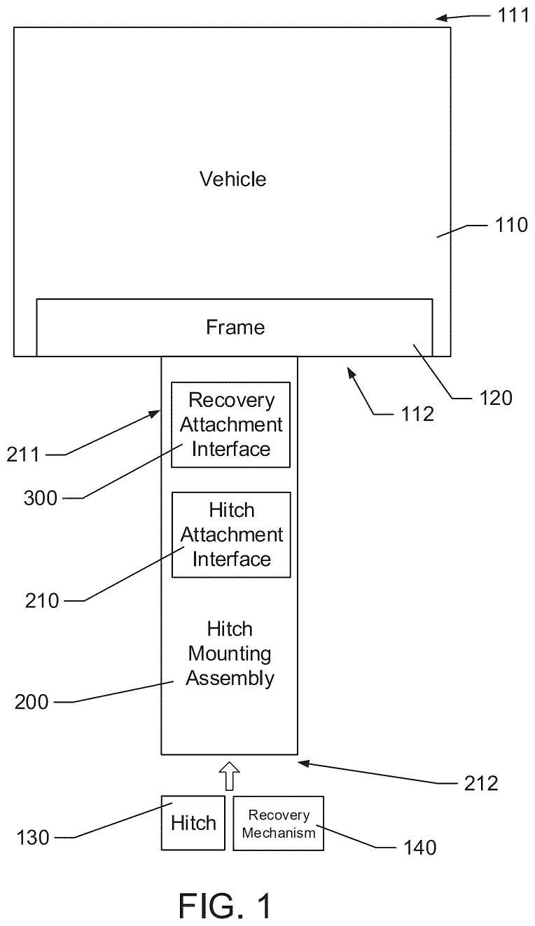

FIG. 1 illustrates a block diagram of a hitch mounting assembly 200 of a vehicle 110 in accordance with an example embodiment. The vehicle 110 may include a front portion 111 and a rear portion 112. The front portion 111 may be proximate an operator of the vehicle 110, and the rear portion 112 may be proximate a trunk or a bed of the vehicle 110. In some cases, the vehicle 110 may include a chassis. In an example embodiment, the chassis may be a frame 120 or body of the vehicle 110. The chassis or frame 120 may support and/or may form the foundation structure of the vehicle 110. In some cases, the chassis and/or frame 120 may be formed of one or more casted or welded metal subframes or may be a unibody construction.

The hitch mounting assembly 200 may be disposed at a rear portion 112 (opposite a front portion 111) of the vehicle 110 and may be operably coupled to the frame 120. The hitch mounting assembly 200 may be operably coupled to the frame 120. In an example embodiment, the hitch mounting assembly 200 may be operably coupled to frame 120 via a fastener, via welding, or via any other coupling method that ensures stable coupling. In some cases, the hitch mounting assembly 200 may be formed integrally with the frame 120. The hitch mounting assembly 200 may be disposed at or operably coupled to the frame 120 at the rear portion 112 of the vehicle 110. In some cases, a first end 211 of the hitch mounting assembly 200 may operably couple to or be disposed at the rear portion 112 of the vehicle 110.

In an example embodiment, the hitch mounting assembly 200 may receive a hitch 130 at a second end 212 of the hitch mounting assembly 200. The second end 212 of the hitch mounting assembly 200 may be a most rearward portion of the vehicle 110. The hitch 130 may operably couple to the hitch mounting assembly 200 via a hitch attachment interface 210. A hitch attachment interface 210 may include orifices on the hitch mounting assembly 200 that correspond to orifices on the hitch 130, in which a fastener may extend through both sets of orifices to operably couple the hitch 130 and the hitch mounting assembly 200 to each other. The hitch attachment interface 210 may also include but is not limited to other fastening techniques, such as locking tabs or welding.

In some cases, the hitch mounting assembly 200 may also include a recovery attachment interface 300. The recovery attachment interface 300 may assist in recovering the vehicle from a position of reduced mobility, such as a loss of traction event. In an example embodiment, a vehicle 110 may experience a position of reduced mobility while off-roading or traversing difficult road conditions. A position of reduced mobility may include tire slip, tire stick, and/or loss of traction. The recovery attachment interface 300 may operably couple with a recovery mechanism 140 to assist in vehicle recovery. The recovery mechanism 140 may transfer force or torque to recovery attachment interface 300, and thus the hitch mounting assembly 200 and the vehicle 110, to assist in repositioning of the vehicle 110 during a recovery operation. The recovery mechanism 140 may be any number of mechanisms to assist in transferring torque to the recovery attachment interface 300 (e.g. chains or locking mechanism). Specifically, the recovery mechanism 140 may also include a soft shackle. A soft shackle may be considered flexible loop that helps operably couple objects together. For example, a soft shackle may be a looped rope or other cord. In some cases, soft shackles may be susceptible to wear from sharp edges of specific attachment geometries. Typical hitch mounting assemblies are not designed to be compatible with soft shackles and thus may cause too much wear on the soft shackle during vehicle recovery efforts.

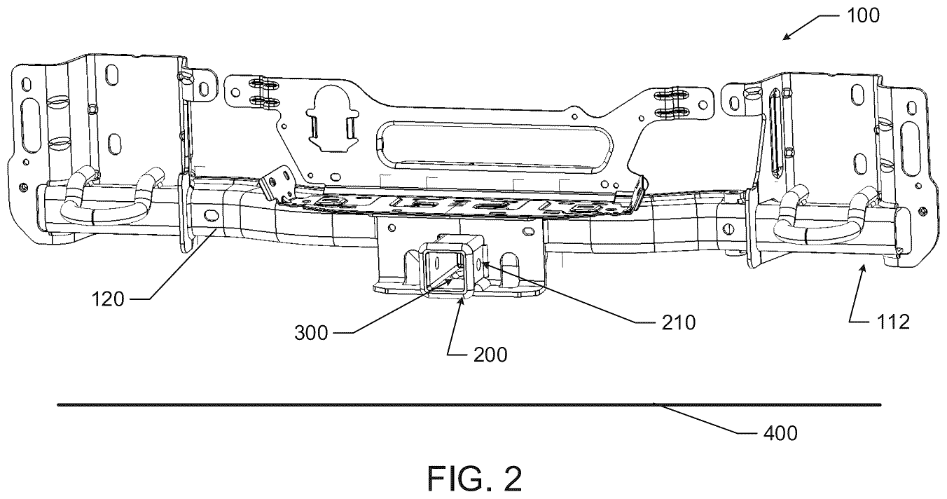

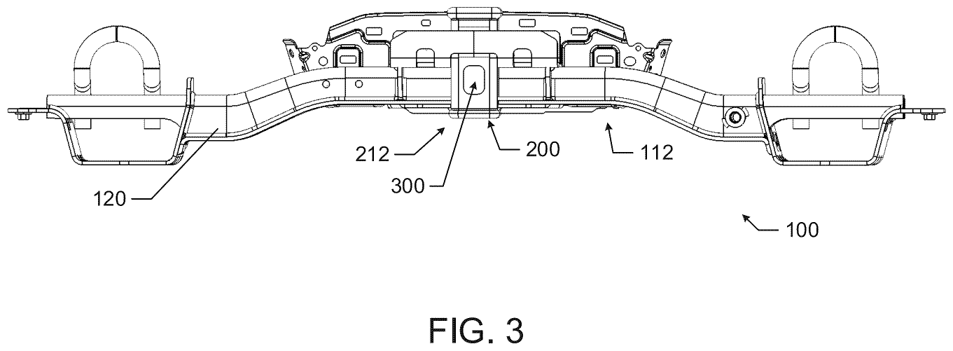

FIGS. 2 and 3 depict perspective and bottom views of the rear portion of the vehicle and the hitch mounting assembly in accordance with an example embodiment. As seen in FIGS. 2 and 3, the hitch mounting assembly 200 may be a hollow rectangular prism-shaped object. The first end 211 and the second end 212 of the hitch mounting assembly 200 may be open to create the hollow structure. In some cases, the frame 120 may operably couple to hitch mounting assembly 200 between the first end 211 and the second end 212. The hitch mounting assembly 200 may also be formed integrally with a bumper of the vehicle 110. In an example embodiment, the hitch mounting assembly 200 may be disposed closer to a driving surface 400 than any other portion of the rear portion 112 of the vehicle 110.

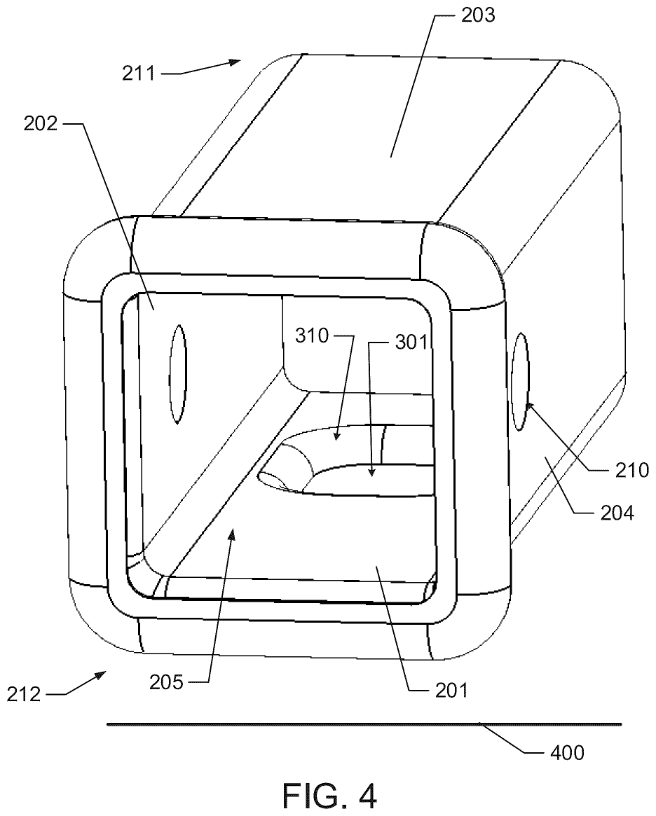

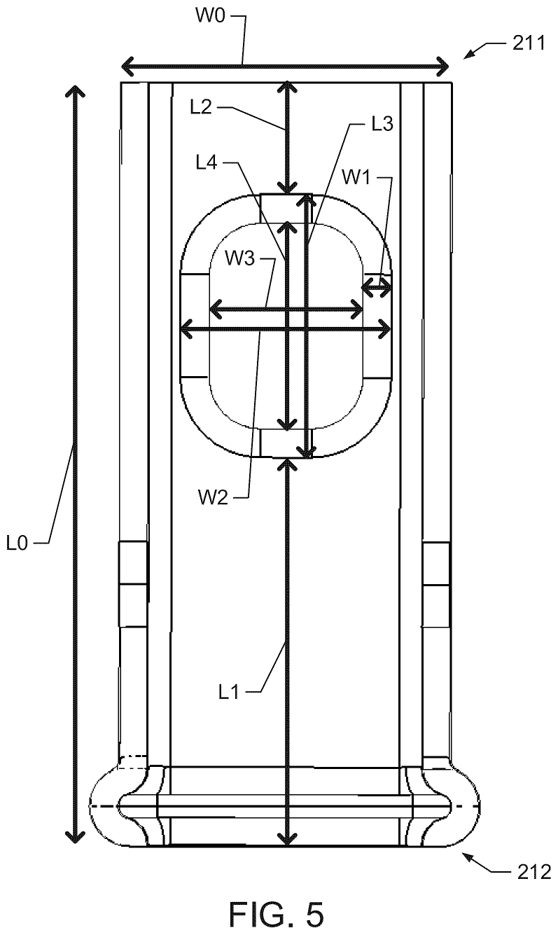

FIGS. 4 and 5 depict a perspective and cross-section view of the hitch mounting assembly according to an example embodiment. The hitch mounting assembly 200 may include a body with a set of sidewalls that define a receiving channel 205. The set of sidewalls may include a first sidewall 201, a second sidewall 202, a third sidewall 203, and a fourth sidewall 204. The recovery attachment interface 300 and the hitch attachment interface 210 may be disposed at different locations in the set of sidewalls. For example, the hitch attachment interface 210 may be orifices disposed at and integrated with the second sidewall 202 and the fourth sidewall 204. The second sidewall 202 and the fourth sidewall 204 may be disposed on opposite sides of the body of the hitch mounting assembly 200 to allow a fastener that operably couples a hitch 130 to the hitch mounting assembly 200 via the hitch attachment interface 210 to extend completely through the hitch mounting assembly 200. The hitch 130 may include a hitch stem to operably couple with the hitch mounting assembly 200 and hitch attachment interface 210.

In some cases, the recovery attachment interface 300 may be disposed at or integrated with the first sidewall 201. The first sidewall 201 may be disposed facing the driving surface 400 of the vehicle 110. Having the recovery attachment interface 300 disposed facing the driving surface 400 may allow the largest freedom of operation for the recovery attachment or soft shackle. In an example embodiment, the recovery attachment interface 300 and the hitch attachment interface 210 may be disposed on different ones of the set of sidewalls. In this regard, the recovery attachment interface 300 and hitch attachment interface 210 may not interfere with one another. The recovery attachment interface 300 may be completely separate from the hitch attachment interface 210.

In an example embodiment, the recovery attachment interface 300 may be a receiving orifice or an aperture disposed in one of the set of sidewalls (e.g. the first sidewall 201). In this regard, a recovery attachment (e.g. the soft shackle) may extend through the second end 212 of the hitch mounting assembly 200 and further extend through the recovery attachment interface 300, so that the recovery attachment extends along both sides (interior and exterior of the hitch mounting assembly 200) of the one of the set of sidewalls where the recovery attachment interface 300 is disposed on. Thus, torque applied to the recovery attachment is transferred to the hitch mounting assembly 200 through the recovery attachment interface 300.

In some cases, to help ensure the performance of the recovery attachment as a soft shackle, the receiving orifice 301 may include a convex fillet 310. A convex fillet 310 may be smooth and rounded to limit any sharp edge interaction with the soft shackle. The convex fillet 310 may surround the entire border of the receiving orifice 301. In an example embodiment, each end of the convex fillet 310 may be orientated 90 degrees from one another. For example, the beginning of the convex fillet 310 at the interior of the hitch mounting assembly 200 may be substantially parallel with the first sidewall 201 and the third sidewall 203, and the end of the convex fillet 310 proximate the exterior of the hitch mounting assembly 200 may be substantially parallel with the second sidewall 202 and the fourth sidewall 204. In this regard, the convex fillet 310 may essentially form a smooth and rounded 90 degree angle that would not disrupt the performance of a soft shackle as a standard right angle corner would.

In an example embodiment, as the recovery attachment interface 300 may include a receiving orifice formed directly in one of the set of sidewalls of the hitch mounting assembly 200, specific dimensions may be needed to ensure the performance of the hitch mounting assembly 200. The hitch mounting assembly 200 may be under various loads, especially with an active hitch 130 attached and in use. Thus, incorporation of the recovery attachment interface 300 may be designed to ensure no compromise in potential loads the hitch mounting assembly 200 can experience.

As seen in the cross section of the hitch mounting assembly 200 of FIG. 5, the recovery attachment interface 300 as a receiving orifice 301 may be disposed closer to the first end 211 of the hitch mounting assembly 200. In this regard, the first length L1 of the sidewall portion between the second end 212 of the hitch mounting assembly 200 and the receiving orifice 301 may be larger than the second length L2 between the first end 211 of the hitch mounting assembly 200 and the receiving orifice 301. In some cases, the entire longitudinal length L0 of the hitch mounting assembly 200 may be the combination of the first length L1, the second length L2, and the third length L3 of the receiving orifice 301 including the convex fillet 310 (or other border or edge of the receiving orifice 301). The fourth length L4 actual opening of the receiving orifice 301 may be the third length L3 minus the first width W1 of the convex fillet 310. The first width W1 of the convex fillet 310 may be constant around the entire border of the receiving orifice 301.

In an example embodiment, the third length L3 and the fourth length L4 may be larger than a second width W2 of the receiving orifice 301 (including convex fillet 310) and a third width W3 of the actual opening of the receiving orifice. In some cases, the entire lateral width W0 of the hitch mounting assembly 200 may be less than the entire longitudinal length L0. In an example embodiment, the first width W1 may be 10 mm, the third width W3 may be 26 mm, and thus the second width W2 may be 46 mm. The entire lateral width W0 may be 54 mm, so the third width W3 (e.g. at 26 mm) may be less than 50% of the width of the entire lateral width W0. The third width W3 of the opening of the receiving orifice 301 being minimally less than 50 % the entire lateral width W0 of the hitch mounting assembly 200 may ensure the performance and stability of the hitch mounting assembly 200 despite adding receiving orifice 301, while maximizing the functionality of the recovery attachment interface 300.

In a similar regard, the fourth length L4 may be 29.48 mm and due to the first width W1 being constant throughout the convex fillet 310, the third length L3 may be 49.48. In an example embodiment, the first length L1 may be 82.52 mm and the second length L2 may be 38 mm. Thus, the entire longitudinal length L0 may be 170 mm. The opening of the receiving orifice 301 may then be disposed fully at the half of the hitch mounting assembly 200 closer to the rear portion 112 of the vehicle 110, so that torque applied to the receiving orifice 301 and thus the hitch mounting assembly 200 is applied closer to the location where the hitch mounting assembly 200 is operably coupled to the vehicle 110. In turn, the stability/performance of the hitch mounting assembly 200 may be maintained during a recovery operation utilizing a soft shackle with the recovery attachment interface 300 as a receiving orifice 301. The minimum length for entire longitudinal length L0 may be 144 mm to ensure compatibility with a plethora of hitches and other hitch mounting assembly attachments.

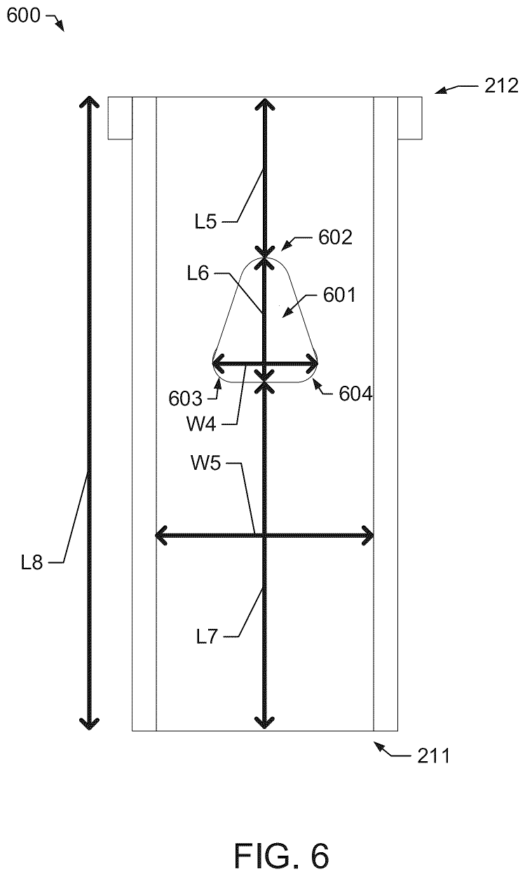

FIG. 6 depicts a cross-section view of a hitch mounting assembly 600 according to an example embodiment. In some cases, the receiving orifice 601 may be a rounded triangle shape (e.g. triangle with rounded corners) as seen in FIG. 6. The rounded triangle shape may include a first corner 602, a second corner 603, and a third corner 604. The first corner 602 may be orientated towards the second end 212 of the hitch mounting assembly 600, and the second corner 603 and the third corner 604 may be orientated towards the first end 211 of the hitch mounting assembly 600. The receiving orifice 601 of the hitch mounting assembly 600 may have not have a convex fillet 310.

In an example embodiment, the receiving orifice 601 may be disposed closer to the second end 212 of the hitch mounting assembly 600 compared to the first end 211 of the hitch mounting assembly 600. Thus, the seventh length L7 between the first end 211 and the receiving orifice 601 may be larger than the fifth length L5 between the second end 212 and the receiving orifice 601. In this regard, the eighth length L8 of the hitch mounting assembly 600 may be the combination of L5, L7, and the sixth length L6 of the receiving orifice 601 between first end 211 and the second end 212. For example, fifth length L5 may be 38 mm, sixth length L6 may be 29.48 mm, and seventh length L7 may be 82.52 mm, so that the eighth length L8 may be 150 mm. In some cases, the fourth width W4 of the receiving orifice 601 and the fifth width W5 of the interior of the hitch mounting assembly 600 may be less than the sixth length L6 and the eighth length L8 respectively.

In an example embodiment, similar to the embodiment depicted in FIGS. 4 and 5, the fourth width W4 may be 26 mm and the fifth width W5 may be 54 mm. In this regard, a maximum width of the fourth width W4 of the receiving orifice 601 may be slightly below 50% of a maximum width of the fifth width W5 of the interior of the hitch mounting assembly 600 to ensure performance of the hitch mounting assembly 600 with the inclusion of the receiving orifice 601.

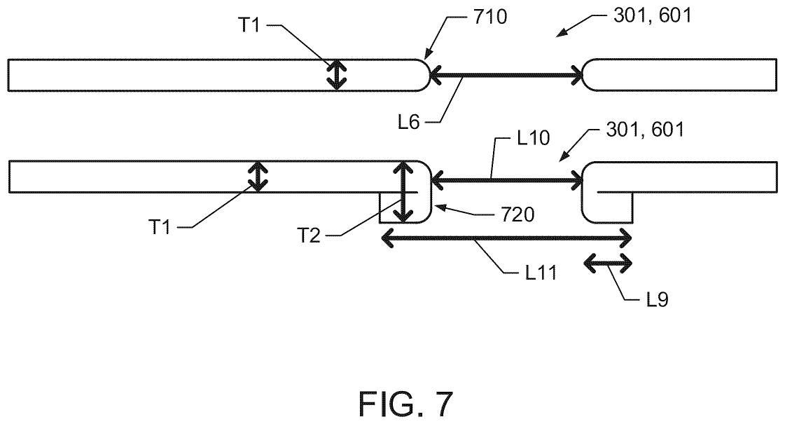

FIG. 7 depicts the recovery attachment interface 300 as a receiving orifice 301, 601 in accordance with an example embodiment. In some cases, if the receiving orifice 301, 601 does not include a convex fillet 310, the receiving orifice 301, 601 may include a rounded edge 710 or a bevel 720. A 3 mm radius of rounded edges may be the minimum radius for soft shackle compatibility. The bevel 720 may be formed of folded over material from the one of the set of sidewalls where the receiving orifice 301, 601 is disposed. The set of sidewalls may have a first thickness T1 at a majority of the sidewall, and a second thickness T2 at the bevel 720 where the material of the sidewall is folded over. The second thickness T2 may be twice the first thickness T1. For example, the first thickness T1 may be 6 mm, and the second thickness T2 may be 12 mm. In some cases, a ninth length L9 of the bevel 720 may be consistent throughout the entire bevel 720. For example, the ninth length L9 may be 10 mm. Thus, similar to the convex fillet 310 embodiment, an eleventh length L11 of the bevel 720 and the receiving orifice 301, 601 may be 49.48 mm, with a tenth length L10 of the receiving orifice 301, 601 being 29.48 mm and the ninth length L9 of the bevel 720 being 10 mm. The rounded edge 710 or the bevel 720 may provide a smooth interface for interaction between the soft shackle and the receiving orifice 301, 601. Adding the bevel 720 to the receiving orifice 301, 601 may increase the surface area of which the soft shackle and recovery attachment interface 300 interact, and thus may distribute the force exerted on the soft shackle to a larger area. The bevel 720 may surround the entire perimeter of the receiving orifice 301, 601. In an example embodiment, the bevel 720 may only be on a portion of the perimeter of the receiving orifice 301, 601 proximate the second end 212 of the hitch mounting assembly 200 (e.g. first corner 602), as the perimeter of the receiving orifice 301, 601 proximate the second end 212 most commonly interfaces with the soft shackle during a recovery operation and thus would reduce the weight of the hitch mounting assembly 200.

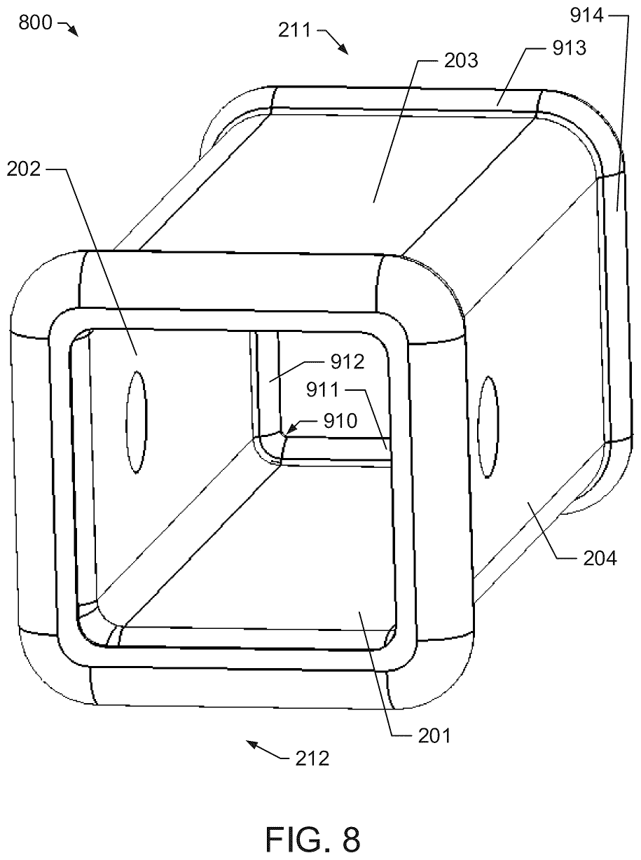

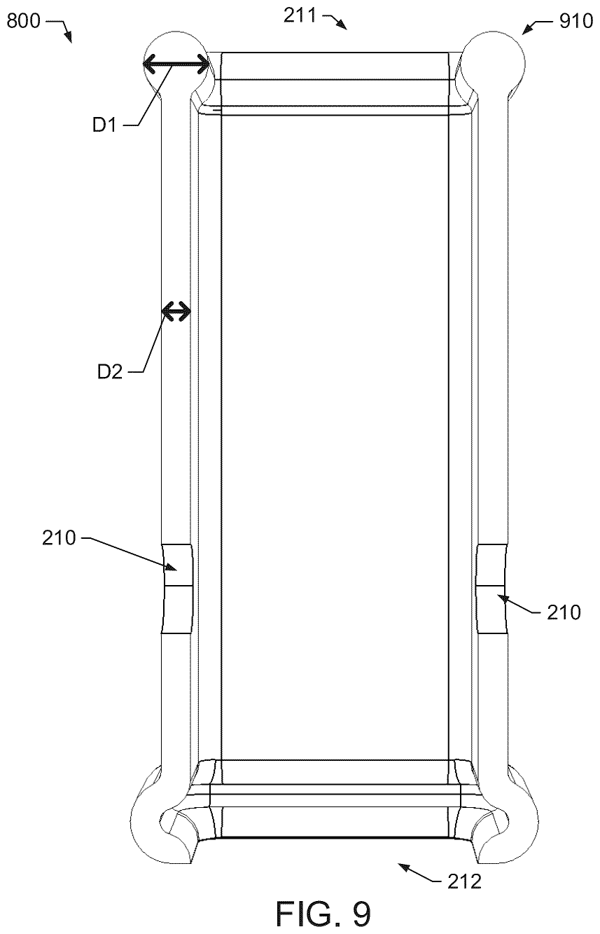

FIGS. 8 and 9 illustrate a hitch mounting assembly 800 in accordance with another example embodiment. In some cases, the recovery attachment interface 300 may be disposed at the first end 211 of the hitch mounting assembly 800. The recovery attachment interface 300 may be a square-shaped collar 910 disposed at the receiving channel 205 of the hitch mounting assembly 800. The square-shaped collar 910 may include a set of cylindrical sides that correspond to the set of sidewalls. For example, the square-shaped collar 910 may include a first cylindrical side 911, a second cylindrical side 912, a third cylindrical side 913, and a fourth cylindrical side 914 that correspond to the first sidewall 201, the second sidewall 202, the third sidewall 203, and the fourth sidewall 204 respectively.

Each one of the set of the cylindrical sides may have a first diameter D1, which may be larger than a second diameter D2 of each one of the set of sidewalls. In some cases, the second diameter D2 may correspond to the first thickness T1 of each one of the set of sidewalls. The first diameter D1 may be at least double the second diameter D2. For example, the first diameter D1 may be 12 mm, and the second diameter D2 may be 6 mm. The larger diameter of the first diameter D1 when compared to the second diameter D2 may increase the surface area of interaction between the soft shackle and recovery attachment interface 300 of the hitch mounting assembly 800, and thus may distribute the force exerted on the soft shackle to a larger area.

A hitch mounting assembly of a vehicle may therefore be provided. The hitch assembly may include a body operably coupled to a rear of the vehicle, the body including a first sidewall, a second sidewall, a third sidewall, and a fourth sidewall defining a receiving channel, a hitch attachment interface integrated with the body, and formed on the second sidewall and the fourth sidewall to operably couple a hitch stem disposed at the receiving channel to the body, and a recovery attachment interface integrated with the body. The recovery attachment interface may be separate from the hitch attachment interface, and the recovery attachment interface may be configured to receive and secure an anchor of a soft shackle.

A hitch mounting assembly of some embodiments may include additional features, modifications, augmentations and/or the like to achieve further objectives or enhance performance of vehicle systems. The additional features, modifications, augmentations and/or the like may be added in any combination with each other. Below is a list of various additional features, modifications, and augmentations that can each be added individually or in any combination with each other. For example, the recovery attachment interface may include a first receiving orifice. In some cases, the first receiving orifice may include a convex fillet. In an example embodiment, the first receiving orifice may be an oval-shape or a rounded triangle-shape. In some cases, the first receiving orifice may be disposed on the first sidewall of the hitch assembly, and the first sidewall of the hitch assembly may be disposed facing a driving surface for the vehicle. In an example embodiment, the first receiving orifice may be formed of folded-over material from the first sidewall, and a first thickness of the first sidewall at the first receiving orifice may be at least double a second thickness of a remainder of the first sidewall. In some cases, the receiving orifice may be disposed closer to a first end of the body than a second end of the body, and the first end may be disposed opposite the second end and closer to a center of the vehicle than the second end. In an example embodiment, the recovery attachment interface may be disposed closer to a front of the vehicle than the hitch attachment interface. In some cases, the recovery attachment interface may be disposed at a first end of the body opposite a second end of the body, and the second end of the body may be configured to receive the hitch stem. In an example embodiment, the recovery attachment interface may define a square-shaped collar disposed at the receiving channel, the collar having four corresponding cylindrical sides to the first sidewall, the second sidewall, the third sidewall, and the fourth sidewall, and a first diameter of each of the four corresponding sides may be larger than a second diameter of a thickness of the body.

A recovery attachment interface of a hitch mounting assembly of a vehicle may be provided. The hitch assembly may include a body operably coupled to a rear of the vehicle, the body including a first sidewall, a second sidewall, a third sidewall, and a fourth sidewall defining a receiving channel, a hitch attachment interface integrated with the body, and formed on the second sidewall and the fourth sidewall to operably couple a hitch stem disposed at the receiving channel to the body, and the recovery attachment interface may be integrated with the body. The recovery attachment interface may be separate from the hitch attachment interface, and the recovery attachment interface may be configured to receive and secure an anchor of a soft shackle

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

Such operations described herein should always be implemented and/or performed in accordance with the owner's manual and safety guidelines.

What is claimed:

1. A hitch mounting assembly of a vehicle, the hitch assembly comprising:
a body operably coupled to a rear of the vehicle, the body including a first sidewall, a second sidewall, a third sidewall, and a fourth sidewall defining a receiving channel;
a hitch attachment interface integrated with the body, and formed on the second sidewall and the fourth sidewall to operably couple a hitch stem disposed at the receiving channel to the body; and
a recovery attachment interface integrated with the body,
wherein the recovery attachment interface is separate from the hitch attachment interface, and
wherein the recovery attachment interface is configured to receive and secure an anchor of a soft shackle.

2. The hitch mounting assembly of claim 1, wherein the recovery attachment interface includes a first receiving orifice.

3. The hitch mounting assembly of claim 2, wherein the first receiving orifice includes a convex fillet.

4. The hitch mounting assembly of claim 2, wherein the first receiving orifice is an oval-shape or a rounded triangle-shape.

5. The hitch mounting assembly of claim 2, wherein the first receiving orifice is disposed on the first sidewall of the hitch assembly, and
wherein the first sidewall of the hitch assembly is disposed facing a driving surface for the vehicle.

6. The hitch mounting assembly of claim 5, wherein the first receiving orifice is formed of folded-over material from the first sidewall, and
wherein a first thickness of the first sidewall at the first receiving orifice is at least double a second thickness of a remainder of the first sidewall.

7. The hitch mounting assembly of claim 2, wherein the receiving orifice is disposed closer to a first end of the body than a second end of the body, and
wherein the first end is disposed opposite the second end and closer to a center of the vehicle than the second end.

8. The hitch mounting assembly of claim 1, wherein the recovery attachment interface is disposed closer to a front of the vehicle than the hitch attachment interface.

9. The hitch mounting assembly of claim 1, wherein the recovery attachment interface is disposed at a first end of the body opposite a second end of the body,
wherein the second end of the body is configured to receive the hitch stem.

10. The hitch mounting assembly of claim 9, wherein the recovery attachment interface defines a square-shaped collar disposed at the receiving channel, the collar having four corresponding cylindrical sides to the first sidewall, the second sidewall, the third sidewall, and the fourth sidewall, and
wherein a first diameter of each of the four corresponding sides is larger than a second diameter of a thickness of the body.

11. A recovery attachment interface of a hitch mounting assembly of a vehicle, the hitch mounting assembly comprising:
a body operably coupled to a rear of the vehicle, the body including a first sidewall, a second sidewall, a third sidewall, and a fourth sidewall defining a receiving channel; and
a hitch attachment interface integrated with the body, and formed on the second sidewall and the fourth sidewall to operably couple a hitch stem disposed at the receiving channel to the body,
wherein the recovery attachment interface integrated with the body,
wherein the recovery attachment interface is separate from the hitch attachment interface, and
wherein the recovery attachment interface is configured to receive and secure an anchor of a soft shackle.

12. The recovery attachment interface of claim 11, wherein the recovery attachment interface includes a first receiving orifice.

13. The recovery attachment interface of claim 12, wherein the first receiving orifice includes a convex fillet.

14. The recovery attachment interface of claim 12, wherein the first receiving orifice is an oval-shape or a rounded triangle-shape.

15. The recovery attachment interface of claim 12, wherein the first receiving orifice is disposed on the first sidewall of the hitch assembly, and
wherein the first sidewall of the hitch assembly is disposed facing a driving surface for the vehicle.

16. The recovery attachment interface of claim 15, wherein the first receiving orifice is formed of folded-over material from the first side, and
wherein a first thickness of the first side at the first receiving orifice is at least double a second thickness of a remainder of the first side.

17. The recovery attachment interface of claim 12, wherein the receiving orifice is disposed closer a first end of the body than a second end of the body, and
wherein the first end is disposed opposite the second end and closer to a center of the vehicle than the second end.

18. The recovery attachment interface of claim 11, wherein the recovery attachment interface is disposed closer to a front of the vehicle than the hitch attachment interface.

19. The recovery attachment interface of claim 11, wherein the recovery attachment interface is disposed at a first end of the body opposite a second end of the body,
wherein the second end of the body is configured to receive the hitch stem.

20. The recovery attachment interface of claim 19, wherein the recovery attachment interface defines a square-shaped collar disposed at the receiving channel, the collar having four corresponding cylindrical sides to the first sidewall, the second sidewall, the third sidewall, and the fourth sidewall, and
wherein a first diameter of each of the four corresponding sides is larger than a second diameter of a thickness of the body.
